(19) United States
(12) Patent Application Publication
(10) Pub. No.: US 2009/0105027 A1
(43) Pub. Date: Apr. 23, 2009

(54) Flat belt

(75) Inventor: Osamu Takahashi, Hyogo (JP)

Correspondence Address: THE WEBB LAW FIRM, P.C., 700 KOPPERS BUILDING, 436 SEVENTH AVENUE, PITTSBURGH, PA, 15219, US

(73) Assignee: BANDO CHEMICAL INDUSTRIES, LTD., Kobe (JP)

(21) Appl. No.: 11/920,478

(22) PCT Filed: May 15, 2006
(86) PCT No.: PCT/JP2006/309653

§ 371 Date: Nov. 15, 2007

(30) Foreign Application Priority Data
May 16, 2005 (JP) 2005-142760

(51) Int. Cl. F16G 1/08

(52) U.S. Cl. 474/249

(57) ABSTRACT

A flat belt that enables the degree of wear thereof to be visually or tactually determined is provided. There is provided a flat belt that has a surface contacting a pulley and a recess formed thereon for detecting wear.

### FIELD OF THE INVENTION

The present invention relates to a flat belt that is wound between pulleys when in use.

### BACKGROUND OF THE INVENTION

Flat belts widely used in the industries transmit power by friction, and therefore are used in a form to constantly cause micro-slippage (elastic slippage). For this, a phenomenon of wear is constantly caused when power is transmitted.

Dealing with troubles, such as cracking and separation, which are generally caused as a result of the use of flat belts, it is possible to visually find those troubles since they are accompanied by cracking or the like, and when a trouble has been found, it can be dealt such as by replacement of a belt.

However, when a surface portion of the flat belt has been evenly worn due to continuous use thereof, the progress of wear is very difficult to be determined, which poses a problem that the timing of replacement of the flat belt cannot be determined.

For example, for checking the progress of wear in a flat belt, frequently employed is measuring of the thickness of the flat belt by using a measuring device, such as a micrometer caliper. However, when measuring a flat belt that transmits power through its both surfaces, the wear rates of both surfaces are different from each other and therefore there is a problem in that it is impossible to determine which surface has been worn when the measurement is made only for the thickness.

Thus, there is a demand for a flat belt that enables its wear degree to be visually or tactually determined.

### SUMMARY OF THE INVENTION

### Problems to be Solved by the Invention

In consideration of the above demand, according to the present invention, an object is to provide a flat belt that enables its wear degree to be visually or tactually determined.

### Means of Solving the Problems

The present inventor repeatedly studied so as to solve the above problem, found that the above problem can be solved by the following invention, and thus achieved the present invention.

According to the present invention, there is provided a flat belt that is characterized in that it has a surface contacting a pulley, and a recess formed therein for detecting wear.

As the surface of the flat belt is worn, the thickness of the flat belt is decreased. By the decrease of the thickness of the flat belt, the depth of the recess provided in the surface of the flat belt becomes smaller, and in a certain arrangement, the width of the recess becomes narrower. Thus, it is possible to visually or tactually determine the wear degree.

In the present invention, the recess preferably has an inclined surface enabling the width of the recess to become smaller towards a bottom of the recess.

With this arrangement, it is possible to determine the wear degree by visually observing not the depth but the width of the recess.

The recess may be in the form of a groove or hole.

### ADVANTAGE OF THE INVENTION

The flat belt of the present invention has a recess in the pulley contacting surface for detecting the wear degree, and therefore the wear status can be perceived by visually or tactually checking the condition of the recess, so that the timing of replacement of the flat belt can be easily determined.

### BRIEF DESCRIPTION OF THE DRAWINGS

FIG. 1 is a cross sectional perspective view of a conventional flat belt.

FIG. 2 is a cross sectional perspective view of a flat belt of an embodiment.

FIGS. 3(a)-3(f) are examples of the flat belt of the embodiment.

### DESCRIPTION OF THE REFERENCE CODES

1: flat belt
10: core codes
20: adhesive rubber layer
30: power-transmission rubber layers

### BEST MODE FOR CARRYING OUT THE INVENTION

Now, the description will be made for an embodiment of the present invention.

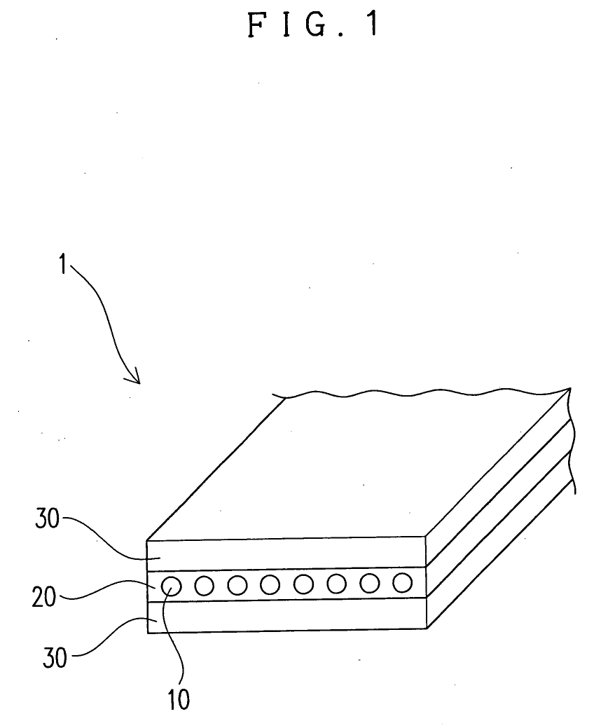

FIG. 1 is a cross sectional perspective view of a conventional flat belt, in which a flat belt 1 is used in, for example, transmitting power to a blower, a compressor, a working machine, etc.

The flat belt has, for example, an adhesive rubber layer 20 with core codes 10 embedded therein.

The adhesive rubber layer 20 has a front side and a rear side, on which power-transmission rubber layers 30 are respectively laminated.

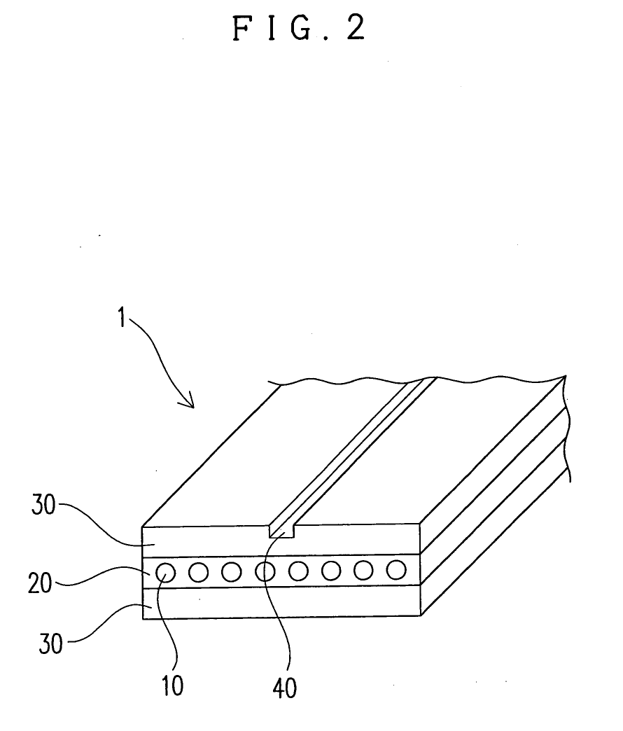

FIG. 2 is a cross sectional perspective view of the flat belt 1 of this embodiment.

The flat belt of this embodiment as illustrated in FIG. 2 has a similar structure to that of the conventional flat belt 1 as illustrated in FIG. 1, but has a recess 40 for detecting the wear on a surface of the power-transmission rubber layer 30.

The recess 40 may be provided on one or both of the power-transmission rubber layers 30 that are laminated on the front and back sides of the adhesive rubber layer 30.

The recess 40 provided in the surface of the power-transmission rubber layer 30 is in the form of a groove 41 or hole 42.

The groove 41 may be a groove having a uniform width throughout its depth or may be a tapered groove having a width which becomes smaller towards its bottom.

The depth of the groove 41 may be appropriately adjusted. The depth may be appropriately adjusted according to an intended timing of the replacement.

Since the timing of the replacement is the time when the adhesive rubber layer 20 has been exposed to the outside by the wear of the power-transmission rubber layer 30 due to friction, the depth of the groove is equal to the thickness of the power-transmission rubber layer 30 at a maximum.

Since the adhesive rubber layer 20 to be exposed due to friction does not act to transmit power, the time when the adhesive rubber layer 20 has been exposed to the outside is designated as the timing of replacement. However, the replacement may be made before that time.

The groove 41 may be formed in the longitudinal direction of the flat belt or in the lateral direction of the flat belt.

When the groove 41 is formed in the longitudinal direction, it may be formed throughout the length of the flat belt, or partially formed in the longitudinal direction of the flat belt. The groove 41 may be formed so as to have its groove width gradually reduced and its depth gradually reduced as it advances towards one side in the longitudinal direction.

Similarly, when the groove 41 is formed in the lateral direction, it may be formed throughout the width of the flat belt, or partially formed in the lateral direction of the flat belt. The groove 41 may be formed so as to have its groove width gradually reduced as it advances in the lateral direction.

The combination of a groove formed in the longitudinal direction and a groove formed in the lateral direction may be employed.

The number of grooves may be appropriately adjusted, and for example, grooves respectively having different depths may be formed. When the grooves having different depths are formed, it is possible to easily check the degree of the progress of wear.

The holes 42 each may be a hole having a uniform diameter throughout its depth or a tapered hole with a diameter reduced towards its bottom (e.g., a hole having a reversed conical shape).

The depth of the hole 42 may be appropriately adjusted. The depth may be appropriately adjusted according to an intended timing of replacement.

Since the timing of replacement is the time when the adhesive rubber layer 20 has been exposed to the outside by the wear of the power-transmission rubber layer 30 due to friction, the depth of the groove is equal to the thickness of the power-transmission rubber layer 30 at a maximum.

The holes 42 may be arranged in the longitudinal direction of the flat belt or in the lateral direction of the flat belt.

When the holes 42 are arranged in the longitudinal direction, they may be formed throughout the length of the flat belt at a predetermined interval or partially formed in the longitudinal direction of the flat belt.

Similarly, when the holes 42 are arranged in the lateral direction, they may be formed at a predetermined interval in the lateral direction.

The combination of holes formed in the longitudinal direction and holes formed in the lateral direction may be employed.

The number of holes, diameter thereof and the like may be appropriately adjusted, and for example, holes having the same hole diameter and different depths may be formed. When holes having different depths are formed, it is possible to easily check the degree of the progress of wear.

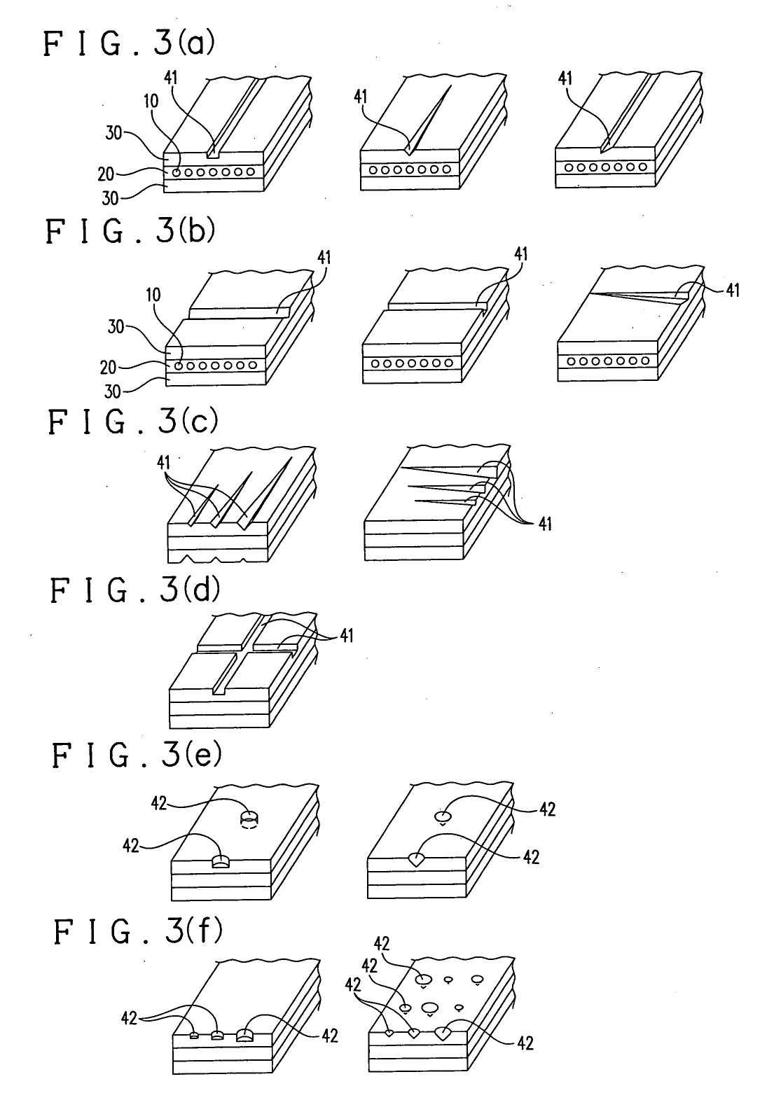

Examples of the flat belt 1 of this embodiment are illustrated in FIGS. 3(a)-(f).

FIG. 3(a) is a cross sectional perspective view of a groove 41 formed in the longitudinal direction of the flat belt 1 (e.g., a groove having a uniform groove width throughout its depth, a tapered groove with an inclined surface enabling a width to be reduced towards its bottom, a groove having a width gradually reduced and a depth gradually reduced as it advances in the longitudinal direction, or the like).

The groove formed in the power-transmission rubber layer 30 enables the degree of wear to be visually or tactually checked. For example, when the groove is of a tapered shape with an inclined surface enabling a width of the groove to be gradually reduced towards its bottom, the degree of wear of the inclined surface can be perceived by touching it, and hence the timing of replacement can be determined.

FIG. 3(b) is a cross sectional perspective view of the groove 41 formed in the lateral direction of the flat belt 1 (e.g., a groove having a uniform groove width throughout its depth, a tapered groove with an inclined surface enabling a width of the groove to be reduced towards its bottom, a groove having a width gradually reduced and a depth gradually reduced as it advances in the lateral direction, or the like).

The groove formed in the power-transmission rubber layer 30 enables the degree of wear to be visually or tactually perceptible.

FIG. 3(c) is cross sectional perspective views, in which plural grooves respectively having different depths are formed in the longitudinal direction or lateral direction, of the flat belt 1 (e.g., grooves each having a uniform groove width throughout its depth, tapered grooves each having an inclined surface enabling a width of the groove to be reduced towards its bottom, grooves each having a width gradually reduced and a depth gradually reduced as it advances in the longitudinal direction, or the like).

The grooves formed in the power-transmission rubber layer 30 enable the degree of wear to be visually or tactually perceptible. That is, the grooves having different depths enable the determination of the current wear status.

FIG. 3(d) is a cross sectional perspective view illustrating the combination of grooves 41 formed respectively in the longitudinal direction and the lateral direction, of the flat belt 1 (e.g., grooves each having a uniform groove width throughout its depth, tapered grooves each having an inclined surface enabling a width of the groove to be reduced towards its bottom, grooves each having a width gradually reduced and a depth gradually reduced as it advances in the longitudinal direction, or the like).

The combination of the grooves respectively formed in the longitudinal direction and the lateral direction makes it possible to determine which portion has been worn and how far each portion has been worn, unless wear evenly proceeds.

FIG. 3(e) is cross sectional views illustrating holes 42 formed in the longitudinal direction or the lateral direction of the flat belt 1 (e.g., holes each having a uniform diameter throughout its depth, or tapered holes each having an inclined surface enabling a diameter of the hole to be reduced towards its bottom).

The holes formed in the power-transmission rubber layer 30 produce the same advantage as that of the arrangement in which grooves are formed.

FIG. 3(f) is cross sectional views illustrating holes 42 having different depths and formed in the longitudinal direction or lateral direction of the flat belt 1, (e.g., holes each having a uniform diameter throughout its depth, or tapered holes each having an inclined surface enabling a diameter of the hole to be reduced towards its bottom). This arrangement also produces the same advantage as that of the arrangement in which grooves are formed.

Now, the description will be made for materials used in manufacturing the flat belt 1 of this embodiment and manufacturing methods.

An unvulcanized rubber composition, such as chloroprene rubber, ethylene-α-olefin elastomer or chlorosulfonated polyethylene, is formed into a sheet, for example, having a thickness of not more than 1 mm and a width of around 1 m by, for example, calender roll. Thus, an unvulcanized rubber sheet is produced for use in manufacturing a flat belt. As core codes disposed in the center of the flat belt, for example, polyethylene terephthalate fibers, polyethylene naphthalate fibers, aramid fibers or vinylon fibers having a denier of several hundred to several thousand, which have been subjected to RFL treatment (bonding treatment), are used.

According to a method of manufacturing the flat belt 1, an unvulcanized rubber sheet is wound around the outer circumference of an cylindrical die to have a thickness of approximately half of the thickness of a flat belt to be manufactured. Then, a core code is wound in spiral fashion at a predetermined distance from each other around the unvulcanized rubber sheet wound around this cylindrical die. Then, an unvulcanized rubber sheet is further wound on this core code to have a thickness (from the surface of the die) slightly thicker than the thickness of the flat belt to be manufactured. Thus, a laminate of the unvulcanized rubber the core code and the unvulcanized rubber is formed on the cylindrical die.

Then, while maintaining this laminated state, it is placed in a rubber cylindrical body, and this rubber cylindrical body and the cylindrical die are introduced into a vulcanizing pan. In this vulcanizing pan, air between the cylindrical die and the rubber cylindrical body is sucked to reduce the pressure, and at the same time high-pressure vapor is introduced from the outside of the rubber cylindrical body to increase pressure and heat, thereby vulcanizing the laminate of rubber, core codes and rubber into an integral body and hence forming a cylindrical belt-preform.

Then, this preform is cooled, then removed from the cylindrical die, and then polished. After polishing, the preform is cut into a predetermined width by a cutting equipment. Thus, a flat belt is produced.

Grooves or holes are formed in the longitudinal direction or lateral direction of the flat belt by cutting the surface of the power-transmission rubber layer 30 by, for example, a buff or drill equipped with a grind stone or cutting tool. The surface of the power-transmission rubber layer 30 may be cut by laser or the like. Thus, grooves or holes may be formed at any desired portions of the flat belt by using those means.

The thickness of a flat belt is reduced as the surface of the flat belt is worn. With reduction of the thickness of the flat belt, the depth of the recess formed in the surface of the flat belt becomes thinner or the width of the recess becomes narrower. Thus, it is possible to visually or tactually determine the degree of wear.

A flat belt is usually wound between pulleys when in use. Depending on the number of pulleys or shape of pulleys, on which the flat belt is to be wound, a flat belt, which has different strengths in a front side and a back side thereof, may be used, so that it is necessary to distinguish between the front and back sides.

For this, a recess is formed on either side of the flat belt so that it is possible to easily distinguish between the front and back sides with the presence of the recess. Furthermore, when recesses are different in shape between the both sides, it is also possible to easily distinguish between the front and back sides. The recess or recesses produce an advantage in that it is possible to visually or tactually and easily distinguish between the front side and the back side when a flat belt is replaced, and visually or tactually and easily determine the degree of wear caused on each side due to use.

1. A flat belt, the flat belt having a surface contacting a pulley, and a recess formed thereon for detecting wear.

2. The flat belt according to claim 1, wherein the recess has an inclined surface enabling the width of the recess to become smaller towards a bottom of the recess.

3. The flat belt according to claim 1, wherein the recess comprises any one of a groove and a hole.

4. The flat belt according to claim 2, wherein the recess comprises any one of a groove and a hole.
